(19) United States
(12) Patent Application Publication
(10) Pub. No.: US 2003/0213377 A1
(43) Pub. Date: Nov. 20, 2003

(54) Food preparation and delivery system

(76) Inventor: Joyce Chatman, Rochester, NY (US)

Correspondence Address: Joyce Chatman, 563 Hague Street, Rochester, NY, 14606, US

(21) Appl. No.: 10/145,249

(22) Filed: May 14, 2002

(51) Int. Cl. A47J 9/00

(52) U.S. Cl. 99/448

(57) ABSTRACT

The present invention is a food system where food is puréed and introduced into individual food pouches. The pouches are placed in a food-serving tray for delivery and serving that has compartments with sizes and shapes corresponding to the pouches. The pouches can have a tube-like extension for filling and discharge of the contents. The pouches can be individually heated or heated while in the tray. The pouches can contain food that is typically not heated when eaten. The food is served via straw or poured into the compartments and eaten with a utensil.

### BACKGROUND OF THE INVENTION

1. Field of the Invention

The present invention is directed to a system for delivering food to individuals.

2. Description of the Related Art

Today food consumption by individuals with eating handicaps often involves an individual preparing the food, cutting the food into small pieces and feeding the small pieces to the handicapped individual. Even then when the individual has a digestive handicap, the small pieces are difficult to digest. What is needed is a food preparation and delivery system that will help with the feeding of people having eating handicaps and digestive problems.

### SUMMARY OF THE INVENTION

It is an aspect of the present invention to provide a system that prepares and delivers food for handicapped individuals.

It is also an aspect of the present invention to provide a system that prepares and delivers food for individuals with digestive problems.

The above aspects can be attained by a food system where food is puréed and preserved in individual food pouches. The pouches are placed in a food-serving tray that has compartments for the pouches. The pouches can be individually heated. The food is served via straw or poured into the compartments and eaten with a utensil.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts a food tray.

FIG. 2 depicts a food pouch.

FIG. 3 depicts a food process.

### DETAILED DESCRIPTION OF THE PREFERRED EMBODIMENTS

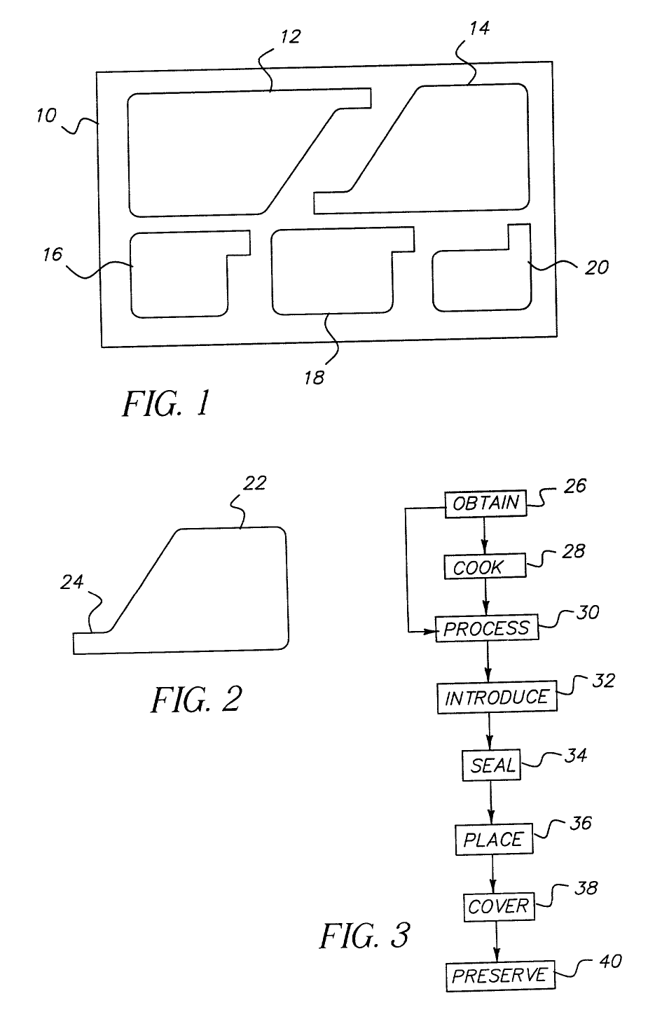

The present invention is designed to provide a food delivery system that is easy for people with eating and digestive handicaps to use. As depicted in FIG. 1 the present invention includes a serving tray 10, much like a frozen food dinner tray, having a number of individual compartments 12-20. The tray is of the type that can be used to preserved food via “cold pasteurization” (radiation) or freezing. The tray is also of the type that can be placed in a microwave oven, an electric or gas convection oven, radiant energy oven or boiling water for heating of the food therein. Each of the individual compartments includes a correspondingly shaped food pouch where FIG. 2 depicts a pouch 22 suitable for compartment 14 of FIG. 1. Each pouch is of the type that can be frozen or irradiated as well as placed in one of the heating units previously discussed. Each pouch can have a tube like extension 24 through which the food can be introduced or discharged by squeezing or into which a straw can be inserted. Each of the food pouches is filled with food that has been chopped, blended or puréed, depending on the eating disabilities of the target individuals, so that the “pieces” of food are smaller than bite sized, such as each piece being smaller than ¼inch in diameter. It is contemplated that the food in the heated pouches can be consumed using a straw inserted into the pouch. The food can also be consumed by opening the pouches via a pouch seam, puncturing the pouch or severing the tube, pouring the food into the compartments of the tray or into conventional food containers, such as a bowl or plate, and eaten with a utensil, such as a spoon or fork.

The food is prepared by obtaining 26 the food desired for each compartment, such as various vegetables, fruit, meat, grains rice, desert, etc. as would be appropriate for a varied or specialized diet. The food can be optionally cooked 28 allowing less desirable components of the food to be removed, such as fat from meat. The food is then processed 30, using a food processor, to the desired consistency from chopped to purée. It may be necessary to cut some foods into smaller pieces for ease of processing. If desired the different types of food can be mixed. The processed food is next introduced 32 into appropriate pouches associated with the compartments. The food can be introduced via a bag having a tube that can be inserted into the tube like extension 24 of the pouch and pressurized, much like a bag with a nozzle that is used for dispensing icing onto a cake via hand squeezing the icing bag. The pouch can have widely opened seam or opening into which food can be poured and which is later sealed. The pouches are then sealed 34, for example, by using heat sealing to bond the tub like extension 24 closed. The pouches are placed 36 in the corresponding compartments of the tray and a cover is fit 38 to the tray much like a cover provided for a frozen or microwave dinner. The cover can be cardboard, plastic, etc. The covered tray can then be inserted into a box for easy handling and shipment. The food in the box is then preserved 40 by freezing the box or passing the box through a preservation unit.

When the consumer obtains the box, the box is opened, the covered tray removed, the cover removed from the tray and the food is heated, as appropriate, and served as previously discussed. The food pouches can all be heated or one or more of the pouches can be heated (and one or more be allowed to thaw when frozen) allowing a food such as meat to be heated while a food such as fruit is not heated.

The present invention has been described with respect to providing the food in individual pouches that fit into compartments of a tray. It is also possible to seal the food into the container compartments without having separate pouches or to have larger pouches for larger food servings each containing a different food.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A food system, comprising:
a compartmented food tray; and
heatable food pouches corresponding to and positioned in the compartments and containing preserved food pieces of a size less than bite sized.

2. A food system as recited in claim 1, wherein the food comprises puréed food.

3. A food system as recited in claim 1, wherein the pouches are capable of being punctured by a straw.

4. A food system as recited in claim 1, wherein food that is not heated when typically consumed is included in one or more pouches.

5. A food system as recited in claim 1, wherein the compartments comprise a filling and discharge extension.

6. A food system, comprising:
a food tray having food compartments of different sizes and shapes and capable of being used in ovens including radiant, microwave and convection heating; and
food pouches having shapes and sizes corresponding to the compartments, each having a tub-like extension for food introduction and discharge, each food pouch containing puréed food, each food pouch capable of being heated by radiant, microwave, convection and boiling heat, each food pouch capable of being cold pasteurized or frozen, one or more food pouches containing food that is typically heated when eaten and one or more pouches containing food that is typically not heated when eaten.
